(19) United States
(12) Patent Application Publication
(10) Pub. No.: US 2010/0110854 A1
(43) Pub. Date: May 6, 2010

(54) DISK DEVICE, AND DATA MOVING PROGRAM AND METHOD

(75) Inventors: MICHIYUKI TANAKA, KAWASAKI (JP); YASUMASA KOIZUMI, CHIYODA (JP)

Correspondence Address: Fujitsu Patent Center;C/O CPA Global, P.O. Box 52050, Minneapolis, MN, 55402, US

(73) Assignee: FIJUTSU LIMITED, KAWASAKI (JP)

(21) Appl. No.: 12/607,684

(22) Filed: Oct. 28, 2009

(30) Foreign Application Priority Data
Oct. 30, 2008 (JP) 2008-279216

(51) Int. Cl. G11B 20/18

(52) U.S. Cl. 369/53.17; G9B/20.046

(57) ABSTRACT

A disk device that records information on a storage medium includes a first reading-out section that reads out defective address information in which a defective address indicative of a physical position of a defective part of the storage medium is recorded; a blocking section that, when a value of intervals between a plurality of the defective addresses in the defective address information which has been read out by the first reading-out section is less than a specific value in terms of a specific unit, sets the specific unit as a defective block; a second reading-out section that reads out data fin the defective block set by the blocking section; and a writing section that writes the data which has been read out by the second reading-out section into an area different from the defective block in the storage medium based on the specific unit.

### CROSS-REFERENCE TO RELATED APPLICATIONS

This application is based upon and claims the benefit of priority of the prior Japanese Patent Application No. 2008-279216, filed on Oct. 30, 2008, the entire contents of which are incorporated herein by reference.

### FIELD

The present invention relates to a process of replacing a storage area in a disk device.

### BACKGROUND

There is known a replacement process in which a sector which causes an error (a defective sector) when data is to be read out therefrom or written thereinto is moved to another safe area in a disk device such as a magnetic disk device. When the defective sector has been replaced to another sector by executing this replacement process, in general, the defective sector is allocated to a different track or disk.

In addition, there are known a storage medium control device constructed such that a hard disk is divided into areas made up of a plurality of sectors and writing in and reading out of data are controlled in units of the divided areas, and an image forming apparatus using the storage medium control device and control methods thereof (for example, see Japanese Laid-Open Patent Publication No. 2002-116931).

However, reading and writing data into and from the sector on which the above mentioned replacing process has been performed necessitates execution of a seeking operation or a head switching operation, which causes a problem that through-put performance of a magnetic disk device is adversely affected. For example, it sometimes occurs that a medium is damaged due to an impact exerted thereon or due to the presence of impurities and so sectors become defective over a wide range. When such a situation occurs, a fine discretization process should be performed due to fragmentation of data, and when the number of areas previously prepared for replacement is reduced, the moving distance of the head and the number of head switching operations are further increased. As a result, reliability is reduced and response processing time needed for data reading and writing is increased.

### SUMMARY

According to an aspect of the embodiment, a disk device that records information on a storage medium includes a first reading-out section that reads out defective address information in which a defective address indicative of a physical position of a defective part of the storage medium is recorded; a blocking section that, when a value of intervals between a plurality of the defective addresses in the defective address information which has been read out by the first reading-out section is less than a specific value in terms of a specific unit, sets the specific unit as a defective block; a second reading-out section that reads out data in the defective block set using the blocking section; and a writing section that writes the data which has been read out by the second reading-out section into an area different from the defective block in the storage medium based on the specific unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 illustrates a higher-order device and a disk device according to an embodiment of the present invention;

FIG. 2 illustrates a disk device configuration according to an embodiment of the present invention;

FIG. 3 illustrates a G-list;

FIG. 4 illustrates operations performed when data-reading fails;

FIG. 5 illustrates operations performed when data-writing fails;

FIG. 6 illustrates operations of a blocking process;

FIG. 7 illustrates operations of a dividing process;

FIG. 8 illustrates an example of the dividing process; and

FIG. 9 illustrates an example of a computer system to which an embodiment of the present invention is applied.

### DESCRIPTION OF EMBODIMENTS

An embodiment of the present invention will be described with reference to the accompanying drawings.

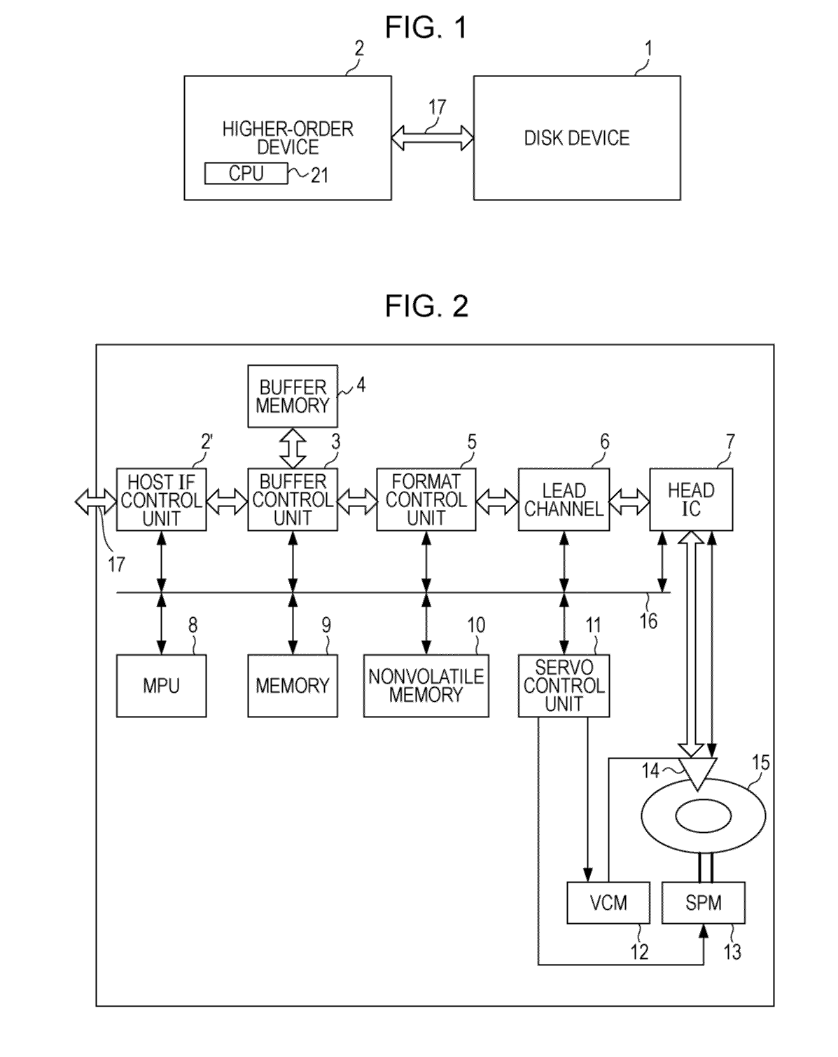

A configuration of a disk device according to an embodiment of the present invention will be described. As illustrated in FIG. 1, a higher-order device 2 at least including a CPU 21 is connected to a disk device 1 via a host IF (Interface) 17. The higher-order device 2 is, for example, a personal computer including the disk device 1 as a storage device thereof and issues commands to the disk device 1 in reading and writing of data.

As illustrated in FIG. 2, the disk device 1 includes a host IF control unit 2′, a buffer control unit 3, a buffer memory 4, a format control unit 5, a lead channel 6, a head IC 7, an MPU 8 (a first reading-out section, a blocking section, a second reading-out section, a writing section, and a setting section), a memory 9, a nonvolatile memory 10, a servo control unit 11, a VCM (Voice Coil Motor) 12, an SPM (Spindle Motor) 13, a read/write head 14 (the first reading-out section, the second reading-out section, and the writing section), a disk medium 15 (a storage medium), a common bus 16, a host IF 17, and a redundancy generation unit 18.

The disk medium 15 is adapted to store data. The read/write head 14 is adapted to write a signal as data into the disk medium 15 and to read out a signal as data from the disk medium 15. The SPM 13 is a motor for rotating the disk medium 15. The VCM 12 is a motor for driving the read/write head 14. The servo control unit 11 is adapted to control the VCM 12 and the SPM 13. The head IC 7 is adapted to amplify a signal to be read out from or written into the disk medium 15 using the read/write head 14. The lead channel 6 is adapted to convert data to be read out from or written into the disk medium 15 into a signal. The format control unit 5 is adapted to generate a record format of data to be recorded on the disk medium 15. The buffer memory 4 is a memory for temporarily storing data to be read out from or written into the disk medium 15. The buffer control unit 3 is adapted to control the buffer memory 4. The memory 9 is a volatile memory. The nonvolatile memory 10 is adapted to store a program used for controlling the disk device 1. The host IF 17 is an IF for communicating with the higher-order device 2 for transmission and reception of data to be read out from or written into the disk medium 15 and commands. The MPU 8 is adapted to execute control and processing performed in the disk device 1.

In general, when data is read out from a disk of the disk device 1 constructed as mentioned above, the data is read out from the disk medium 15 using the read/write head 1 and transmitted to the lead channel 6 via the head IC 7. The data transmitted to the lead channel 6 is sent to the buffer memory 4 via the format control unit 5 and the buffer control unit 3 to be temporarily held in the buffer memory 4. The data held in the buffer memory 4 is transmitted to the higher-order device 2 via the host IF control unit 2 and the host IF 17. On the other hand, when data is written into the disk medium 15, the data is transmitted from the higher-order device 2 to the buffer memory 4 via the host IF 17, the host IF control unit 2′, and the buffer control unit 3 to be temporarily held in the buffer memory 4. The data held in the buffer memory 4 is transmitted via the format control unit 5, the lead channel 6, and the head IC 7 to the disk medium 15 to be written into the disk medium 15 using the read/write head 14 at a time which is appropriate for data writing.

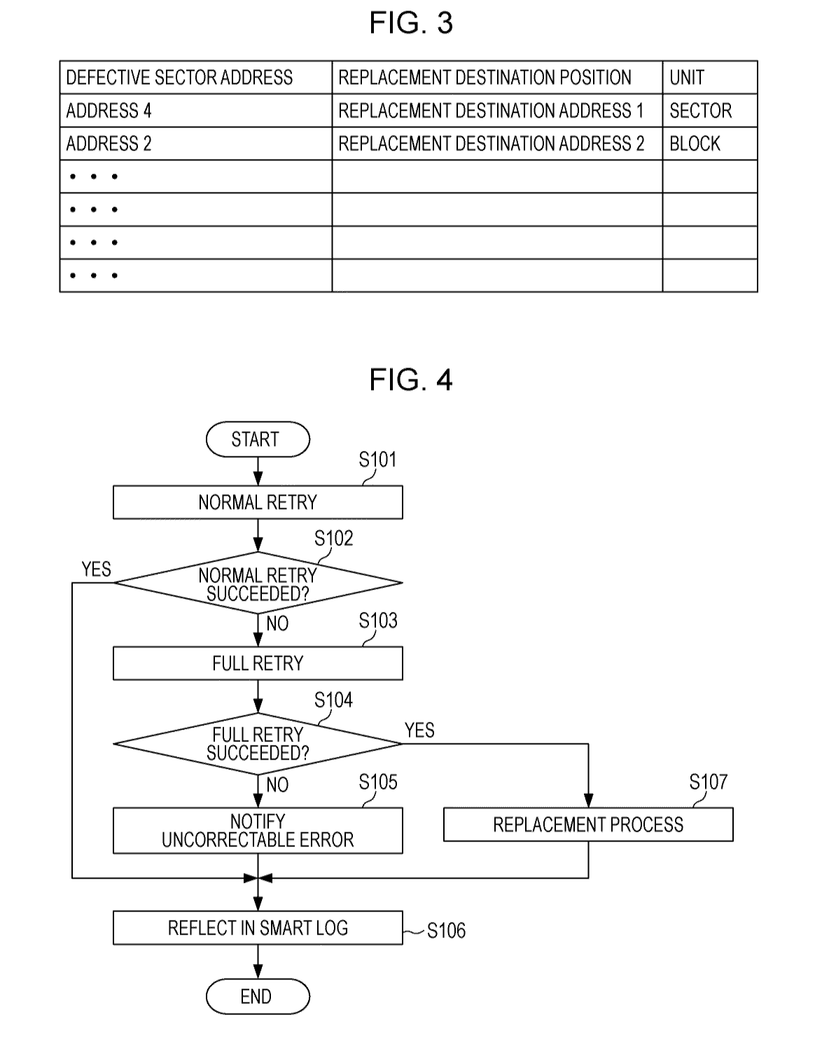

A G-list (defective address information) used for recording defective sectors or non-readable and non-writable sectors is recorded in a system area of the disk medium 15. FIG. 3 illustrates the G-list.

As illustrated in FIG. 3, the G-list is information in which defective sector addresses (defective addresses), addresses of replacement destinations thereof (addresses of moving destinations thereof), and units expressed in terms of “blocks” and “sectors” are registered in correspondence to one another. Although, in an embodiment of the present invention, these addresses are supposed to be LBAs (Logical Block Addresses), any address may be used as long as the addresses are made to originate from addresses (sequential addresses) sequentially indicating physical positions of sectors. In an embodiment of the present invention, it is also assumed that the G-list is read out from the system area of the disk medium 15 using the read/write head 14 upon startup and is temporarily stored in the memory 9. Note that units placed on the G-list will be described below.

Next, operations performed when the disk device according to an embodiment of the present invention has failed at reading data thereinto will be described. FIG. 4 illustrates the operations performed when data-reading has failed. It is assumed that in the situation illustrated in FIG. 4, the disk device has already failed at reading data in a specific area.

First, the MPU 8 executes normal retry on the data for which reading into the device has failed (S101) and judges whether the data has been read into the device by execution of the normal retry (S102).

When the data has not been read into the device by execution of the normal retry (S102, NO), the MPU 8 executes full retry on the data for which reading into the device has failed (S103) and judges whether the data has been read into the device by execution of the full retry (S104). Note that the full retry is a retrying process to be performed on a sector which cannot be read into the device by execution of the normal retry, that is, the full retry a retrying process having a higher possibility of succeeding in reading data into the device than the normal retry. As an example of the full retry, a retrying process which is different from the normal retry in terms of the position of the read/write head 14 relative to the disk medium 15 can be given.

When the data cannot be read into the device by execution of the full retry (S104, NO), the MPU 8 notifies the higher-order device 2 of an uncorrectable error via the host IF 17 (S105) and makes parameters relating to defective sectors that include the data be reflected in a SMART (Self-Monitoring, Analysis and Reporting Technology) log (S106).

On the other hand, when the data has been read into the device by execution of the full retry (S104, YES), the MPU 8 executes a replacement process (S107). The defective sector that includes the data which could not be read into the device is moved to another area and the position of the defective sector and the position of a moving destination to which the defective sector has been moved are written into the G-list illustrated in FIG. 3 in correspondence to each other.

When the data has been read into the device by execution of the normal retry in the operation at S102 (S102, YES), the MPU 8 reflects the parameters relating to the defective sectors that include the data in the SMART log (S106).

Note that it is assumed that the unit written into the G-list is “sector” in the above mentioned replacing process.

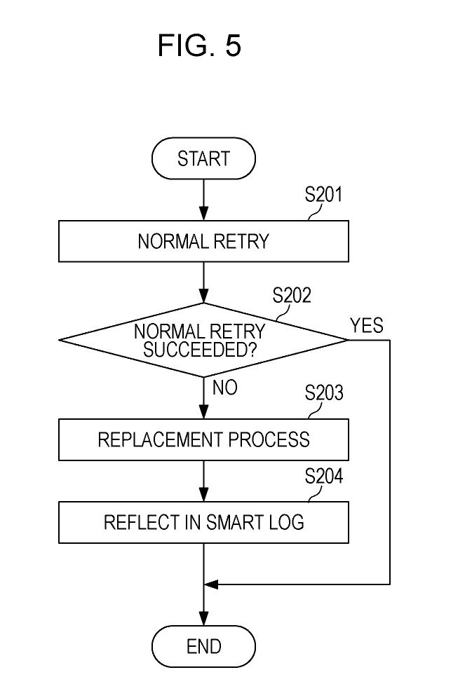

Next, operations performed when data writing into the disk device according to an embodiment of the present invention has failed will be described. FIG. 5 illustrates the operations performed when data-writing has failed. Note that in the situation illustrated in FIG. 5, it is assumed that the disk device has already failed in writing data into a specific area.

First, the MPU 8 executes the normal retry (S201) and judges whether the data has been written into the disk device by execution of the normal retry (S202).

If the data could not be written into the device by execution of the normal retry (S202, NO), the MPU 8 executes the above mentioned replacement process (S203) and makes parameters relating to defective sectors that include the data be reflected in the SMART log (S204).

On the other hand, if the data has been written into the device by executing the normal try (S202, YES), the MPU 8 terminates the process.

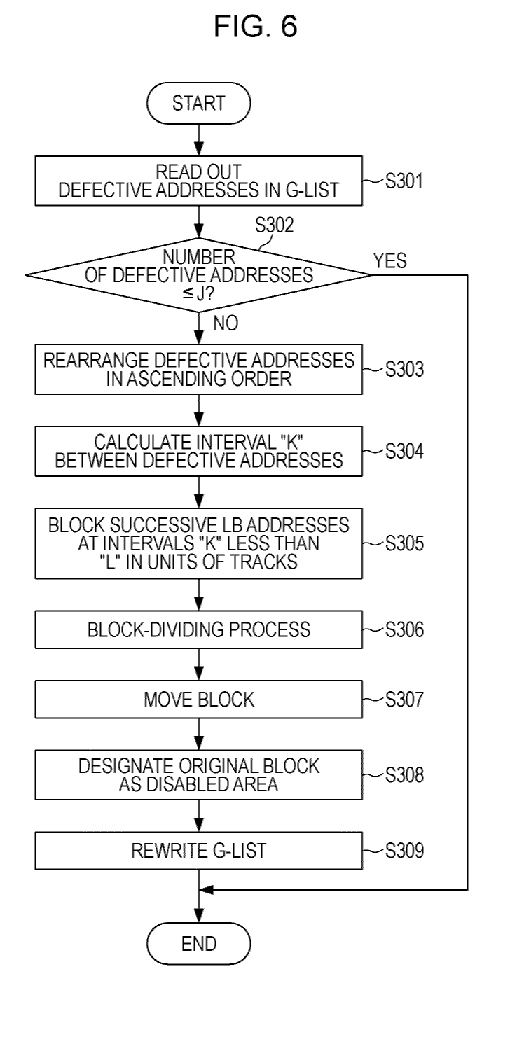

Next, a blocking process will be described. In the blocking process, when the interval between the plurality of defective sectors which have been already moved by executing the replacement process is less than a specific interval, the plurality of defective sectors are gathered into a defective block and the defective block so gathered is moved to another area. Although, in an embodiment of the present invention, it is assumed that the blocking process is periodically executed at specific time intervals, any other situation may be used as a trigger. As triggers of the blocking process, for example, user instructions given via the higher-order device or the performance of the disk device 1 may be considered. FIG. 6 illustrates operations of the blocking process.

First, the MPU 8 reads out the LBAs as addresses of defective sectors whose unit is a sector in the G-list (S301, a first reading-out operation) and judges whether the number of LBAs registered in the G-list is smaller than a specific number “J” (S302).

When the number of LBAs registered in the G-list is larger than the specific number “J” (S302, NO), the MPU 8 rearranges the LBAs indicative of the positions of sectors before the replacement process is performed in number-based ascending order (S303). The MPU 8 calculates a value “K” of intervals between respective LBAs (S304) and gathers a plurality of successive LBAs arrayed at intervals of “K” which is smaller than a specific value “L” into a defective block in units of tracks (S305, a blocking operation). Note that the MPU 8 gathers successive LBAs including sectors which are not defective sectors situated between defective sectors into the defective block in units of tracks.

Next, a later described block-dividing process is performed using the CPU 21 of the higher-order device 2 (S306, the blocking operation) and the MPU 8 moves the defective block to the other area (S307, a second reading-out operation and a writing operation). Data made up of the defective blocks is read out from the disk medium using the read/write head 14, is temporarily stored in the buffer memory 4, and is then written into the other area at one time. In the example illustrated in FIG. 6, it is assumed that the defective sectors made up of the defective blocks are read out from the positions of replacement destinations which are registered in the G-list in correspondence to one another. Next, the MPU 8 designates the original block (the area where the defective block was stored before movement) as a disabled area (S308, a setting operation), writes the LBA of the original block and the LBA of the moving destination into the G-list, and sets the unit registered in correspondence to the LBAs to the “block” (S309). It is assumed that the values “J” and “L” used in the blocking process are determined based on the number of sectors in one track. For example, if one track is made up of 18 sectors, since the defective block is formed in units of tracks, the value “J” will be larger than at least 18. Sectors of replacement destinations of the defective sectors in the original block may be used as sectors into which data is normally written or may be used again as the sectors of replacement destinations.

When the number of LBAs registered in the G-list is smaller than the specific value “J” in the operation at S302 (S302, YES), the MPU 8 terminates the blocking process.

As described above, by moving the data in units of defective blocks including sectors which are not defective such as sectors situated between defective sectors, fragmentation of data which has been moved may be avoided. In addition, there is a possibility that unevenness or a foreign material is present on a disk surface in a defective sector of the disk medium 15, so that the head may be prevented from colliding with a uneven part (or the foreign material on the disk surface) of the disk medium 15 by designating a track which has been judged to be a defective block as a disabled area.

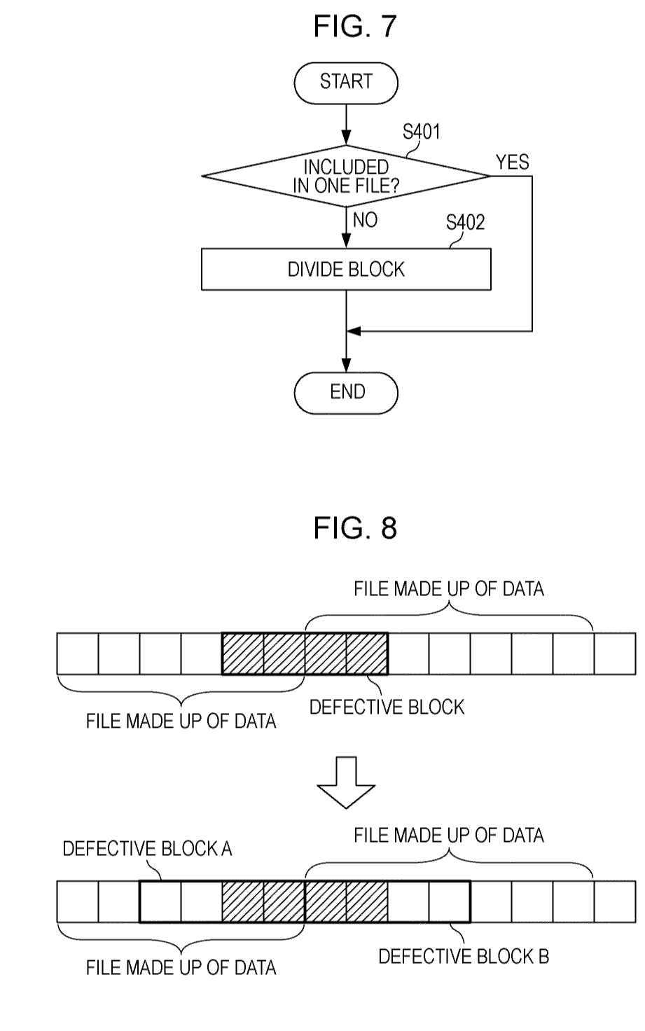

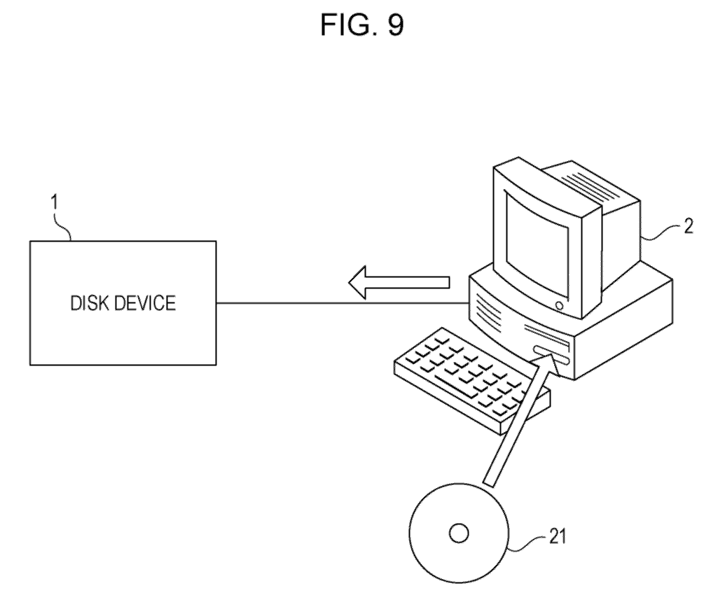

Next, a block-dividing process will be described. The block-dividing process is a process performed at S306 in FIG. 6 in order to divide a defective block into several blocks. In this process, judgment is made based on a “file” (a unit) handled in the higher-order device. FIG. 7 is a flowchart illustrating operations performed in the block-dividing process. FIG. 8 illustrates examples of the block-dividing process.

First, the CPU 21 of the higher-order device 2 judges whether the defective block is included in one specific file (S401).

In the case that the defective block is not included in one specific file (S401, NO), the MPU 8 divides the defective block in units of files into a plurality of defective blocks such as a defective block A and a defective block B as illustrated in FIG. 8.

On the other hand, when the defective block is included in one specific file (S401, YES), the MPU 8 terminates the block-dividing process.

The access time needed to access a defective block after the block has been moved to the other area may be reduced upon accessing a file by dividing the defective block into the plurality of blocks so as to prevent the defective block from extending over a plurality of files as described above. The operations performed in the above mentioned dividing process are mere examples and any process may be employed as long as a defective block can be held in one file by executing the process concerned. For example, when data of a plurality of files is included in a plurality of defective blocks, the data in each detective block may be sorted in units of files and the defective blocks may be re-configured based on the sorted data.

The present invention can be embodied in a variety of ways without departing from the gist or essential characteristics thereof. Thus, the above mentioned embodiments are mere examples in all respects and should not be construed as being limiting. The scope of the present invention is indicated by the scope of the appended claims and is not limited by the body of the specification. In addition, all changes, and various improvements, alterations and modifications falling within a scope equivalent to the scope of the appended claims are possible within the scope of the present invention.

Further, a program used to make the disk device 1 execute each of the above mentioned operations may be provided as a data moving program. Causing the disk device 1 to execute the operations of the above mentioned program is made possible by storing the program in a recording medium from which the MPU 8 can read out data stored therein. As an alternative, a computer system as the higher-order device 2 connected to the disk device 1 as illustrated in FIG. 9 may be made to read data stored in a storage medium 21′ and to transmit a filtering program to the disk device 1 as a filter device. In this respect, as storage media from which the device 2 as a setting terminal may read out data stored therein, internal memories mounted in computers such as ROMs and RAMs, mobile storage media such as CD-ROMs, flexible disks, DVD disks, magneto-optic disks and IC cards, databases holding computer programs, other computers and databases thereof, and media transmittable over a communication line are included.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

1. A disk device that records information on a storage medium, the device comprising:
a first reading-out section that reads out defective address information in which a defective address indicative of a physical position of a defective part of the storage medium is recorded;
a blocking section that, when a value of intervals between a plurality of the defective addresses in the defective address information which has been read out by the first reading-out section is less than a specific value in terms of a specific unit, sets the specific unit as a defective block;
a second reading-out section that reads out data in the defective block set by the blocking section; and
a writing section that writes the data which has been read out by the second reading-out section into an area different from the defective block in the storage medium based on the specific unit.

2. The device according to claim 1, wherein
the blocking section sets the defective block so as to be held in a unit managed by a higher-order device which uses data recorded on the storage medium.

3. The device according to claim 1, wherein
the specific unit is a track.

4. The device according to claim 1, further comprising
a setting section that sets a track which has been judged to be a defective block by the blocking section, as a disabled area.

5. The device according to claim 1, wherein
the defective address information is information in which the defective address is registered in correspondence to a moving destination address that is an address of a destination to which the data of the defective address has been moved, and
the second reading-out section reads out data of the moving destination address which is registered in correspondence to the defective address of the defective block upon reading out the data of the defective block.

6. The device according to claim 2, wherein
the unit managed by the higher-order device is a file.

7. A computer-readable storage medium that stores a data moving program, wherein
the program causes a computer to:
read out defective address information in which a defective address indicative of a physical position of a defective part of the storage medium is recorded;
set a specific unit as a defective block when a value of intervals between a plurality of the defective addresses in the read out defective address information is less than a specific value in terms of the specific unit;
read out data in the set defective block; and
write the read-out data into an area which is different from the defective block in the storage medium based on the specific unit.

8. The program according to claim 7, wherein
the program further causes the computer to set the defective block so as to be held in a unit managed by a higher-order device which uses the data recorded on the storage medium.

9. The program according to claim 7, wherein
the specific unit is a track.

10. The program according to claim 9, wherein
a track which has been judged to be a defective block is set as a disabled area.

11. The program according to claim 7, wherein
the defective address information is information in which the defective address is registered in correspondence to a moving destination address which is an address of a destination to which data of the defective address has been moved, and
the program further makes the computer read out data of the moving destination address which is registered in correspondence to the defective address of the defective block upon reading out the data of the defective block.

12. The program according to claim 8, wherein
the unit managed by the higher-order device is a file.

13. A data moving method used in a disk device that records information on a storage medium, the method comprising:
reading out defective address information in which a defective address indicative of a physical position of a defective part of the storage medium is recorded;
setting the specific unit as a defective block when a value of intervals between a plurality of the defective addresses in the read-out defective address information is less than a specific value in terms of a specific address;
reading out data in the set defective block; and
writing the read-out data into an area which is different from the defective block in the storage medium based on the specific unit.

14. The method according to claim 13, further comprising:
setting the defective block so as to be held in a unit managed by a higher-order device which uses data recorded on the storage medium.

15. The method according to claim 13, wherein
the specific unit is a track.

16. The method according to claim 15, further comprising:
setting a track which has been judged to be a defective block as a disabled area.

17. The method according to claim 13, wherein
the defective address information is information in which the defective address is registered in correspondence to a moving destination address which is an address of a destination to which data of the defective address has been moved, and further comprising:
upon reading out the data of the defective block, reading out data of the moving destination address which is registered in correspondence to the defective address of the defective block.

18. The method according to claim 14, wherein
the unit managed by the higher-order device is a file.
